(19) United States
(12) Patent Application Publication
(10) Pub. No.: US 2009/0122037 A1
(43) Pub. Date: May 14, 2009

(54) Plasma display panel and method of driving the same

(76) Inventor: Kunio Takayama, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/285,684

(22) Filed: Oct. 10, 2008

(30) Foreign Application Priority Data
Nov. 8, 2007 (KR) 10-2007-0113810

(51) Int. Cl. G09G 5/00; G09G 3/28

(52) U.S. Cl. 345/205; 345/60

(57) ABSTRACT

There is provided a method of driving a plasma display panel (PDP) capable of reducing an address period. The method of driving a PDP includes supplying scan signals to scan lines and supplying data signals to address electrodes. Each of the scan lines includes a scan pulse, and each of the data signals includes a data pulse. Each of the data signals is synchronized with one of the scan signals. The data pulse of the each of the data signals precedes the scan pulse of the synchronized scan signal.

### CLAIM OF PRIORITY

This application makes reference to, incorporates the same herein, and claims all benefits accruing under 35 U.S.C. §119 from an application for PLASMA DISPLAY PANEL AND METHOD OF DRIVING THE SAME earlier filed in the Korean Intellectual Property Office on the 8th of Nov. 2007 and there duly assigned Serial No. 10-2007-0113810.

### BACKGROUND OF THE INVENTION

1. Field of the Invention

The present invention relates to a plasma display panel and a method of driving the same, and more particularly, relates to a plasma display panel capable of reducing an address period and a method of driving the same.

2. Description of the Related Art

FIG. 1 illustrates a diagram of one frame of driving signals of a plasma display panel (PDP). Referring to FIG. 1, one frame of the driving signal of a PDP includes a plurality of subfields SF1 to SF8. Each subfield is divided into a reset period for initializing an entire screen, an address period for selecting discharge cells, and a sustain period for generating discharge in the discharge cells selected in the address period for a predetermined time.

In the reset period, ramp pulses are supplied to scan electrodes to form predetermined wall charges in the discharge cells so that next address discharge can be stably performed. In the reset period, the discharge cells of the entire screen are initialized.

In the address period, scan pulses are supplied to the scan electrodes and data pulses are supplied to address electrodes in synchronization with the scan pulses. Then, address discharge is generated in the discharge cells to which the data pulses are supplied so that predetermined wall charges are formed.

In the sustain period, sustain pulses are alternately supplied to the scan electrodes and sustain electrodes so that sustain discharge is generated in the discharge cells selected by the address discharge. Here, an image of predetermined brightness is displayed on the PDP to correspond to the number of times where the sustain discharge is generated.

FIG. 2 illustrates driving waveforms supplied in the address period. While referring to FIG. 2, for convenience sake, it is assumed that three address electrodes and five scan electrodes are provided.

Referring to FIG. 2, in the address period, the scan pulses are sequentially supplied to the scan electrodes Y1 to Y5. Then, whenever the scan pulses are supplied, the data pulses are supplied to the address electrodes A1 to A3. Here, various shapes of data pulses are supplied in response to data from the outside. In FIG. 2, “H” means that the data pulses are supplied to correspond to the data and “L” means that the data pulses are not supplied to correspond to the data.

In FIG. 2, when the scan pulses are supplied, the data pulses having the same width as the width of the scan pulses are supplied to discharge the address discharge in the discharge cells. However, as illustrated in FIG. 2, when the scan pulses are sequentially supplied to the scan electrodes Y1 to Y5 and the data pulses having the same width as the scan pulses are supplied to the address electrodes A1 to A3, the portion occupied by the address period in each of the subfields SF1 to SF8 increases. Actually, in a full HD-level panel including a plurality of scan electrodes Y, sufficient time is not assigned to the sustain period that contributes to brightness due to an increase in the address period.

### SUMMARY OF THE INVENTION

Accordingly, it is an object of the present invention to provide a plasma display panel capable of reducing an address period and a method of driving the same.

In order to achieve the foregoing and/or other objects of the present invention, a method of driving a plasma display panel (PDP) according to an embodiment of the present invention includes supplying scan signals to the scan electrodes where each of the scan lines includes a scan pulse, and supplying data signals to the address electrodes where each of the data signals includes a data pulse. Each of the data signals is synchronized with one of the scan signals. The data pulse of the each of the data signals precedes the scan pulse of the synchronized scan signal.

A rising point of time of the data pulse of the each of the data signals may precede a falling point of time of the scan pulse of the synchronized scan signal. A width of the data pulse of the each of the data signals may be larger than a width of the scan pulse of the synchronized scan signal. The width of the data pulse may be larger than the width of the scan pulse by between 40 nanoseconds and 260 nanoseconds. A scan pulse of one of the scan signals may overlap with a scan pulse of a next scan signal to the one of the scan signals by a first period, and a data pulse of one of the data signals may overlap with a data pulse of a next data signal to the one of the data signals by a second period. The first period may be no greater than 220 nanoseconds. The second period may be between 40 nanoseconds and 260 nanoseconds. A voltage of a base voltage source is supplied to the address electrodes when the data pulses are not supplied to the address electrodes in an address period. A first voltage higher than a voltage of a base voltage source is supplied to the address electrodes when the data pulses are not supplied to the address electrodes in the address period.

A method of driving a PDP according to another embodiment of the present invention includes supplying scan signals to the scan electrodes where each of the scan lines includes a scan pulse; and supplying data signals to the address electrodes where each of the data signals includes a data pulse. Each of the data signals is synchronized with one of the scan signals. A width of the data pulse of the each of the data signals is larger than a width of the scan pulse of the synchronized scan signal. A data pulse of one of the data signals overlaps with a data pulse of a next data signal to the one of the data signals by a second period.

The width of the data pulse may be larger than the width of the scan pulse by between 40 nanoseconds and 260 nanoseconds. A scan pulse of one of the scan signals may overlap with a scan pulse of a next scan signal to the one of the scan signals by a period between 0 nanoseconds and 220 nanoseconds. The second period may be between 40 nanoseconds and 260 nanoseconds. A voltage of a base voltage source is supplied to the address electrodes when the data pulses are not supplied to the address electrodes in an address period. A first voltage higher than a voltage of a base voltage source is supplied to the address electrodes when the data pulses are not supplied to the address electrodes in the address period.

A PDP according to an embodiment of the present invention includes a plurality of address electrodes, a plurality of scan electrodes, a scan driver for supplying scan signals to scan electrodes, first switches, each of which is coupled between an address voltage source and one of the address electrodes, second switches, each of which is coupled between an energy recovery capacitor and one of the address electrodes, and third switches, each of which is coupled between a base voltage source and one of the address electrodes. The first switches are turned on in order to supply an address voltage to the address electrodes. The second switches are turned on when a voltage of data pulses rises or falls. The third switches are turned on in order to supply a voltage of a base voltage source. Turning on and off timings of the second switches are controlled so that the rising point of time and the falling point of time of the data pulses do not overlap each other.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates one frame of driving signals of a plasma display panel (PDP);

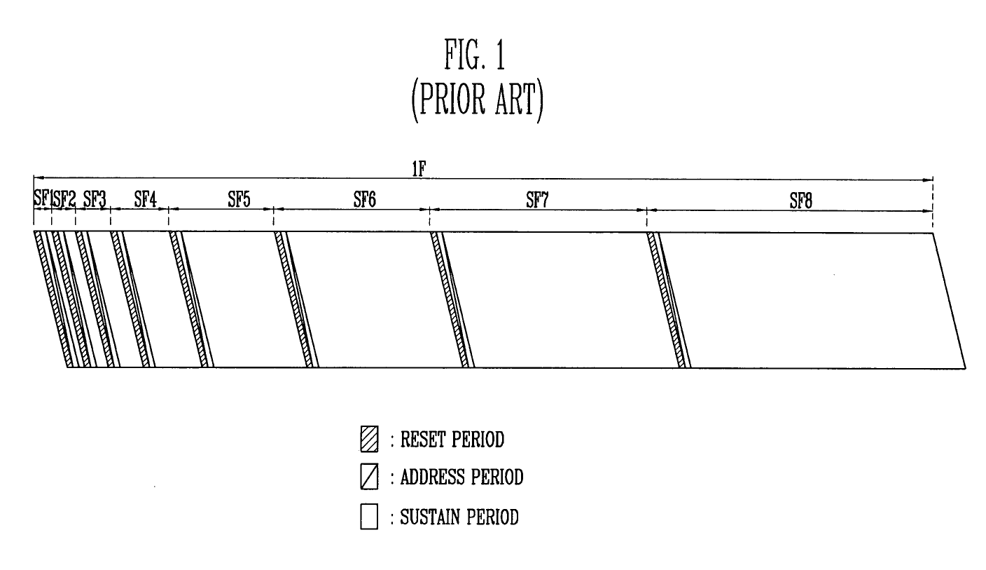

FIG. 2 illustrates driving waveforms supplied in the address period of FIG. 1;

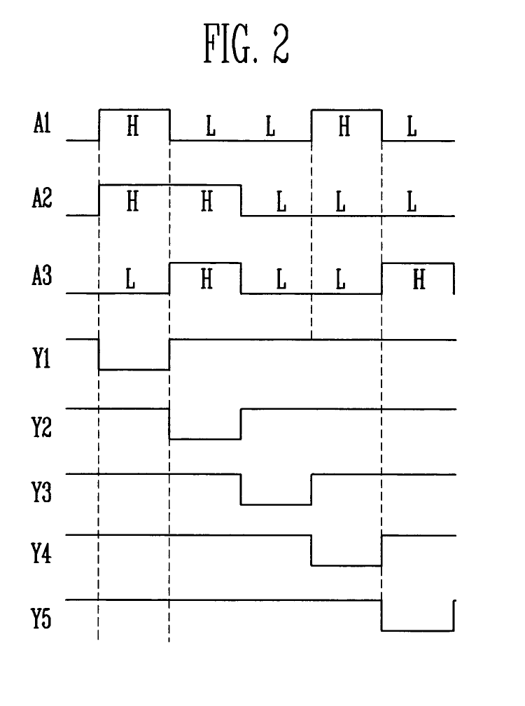

FIGS. 3A and 3B illustrate driving waveforms supplied in the address period according to an embodiment of the present invention;

FIGS. 4 and 5 are graphs illustrating discharge delay corresponding to the widths of data pulses and scan pulses;

FIG. 6 illustrates a PDP according to an embodiment of the present invention;

FIG. 7 illustrates an output end included in the address driver of FIG. 6;

FIG. 8 illustrates data pulses supplied by the output end of FIG. 7; and

FIG. 9 illustrates driving waveforms supplied in the address period according to another embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

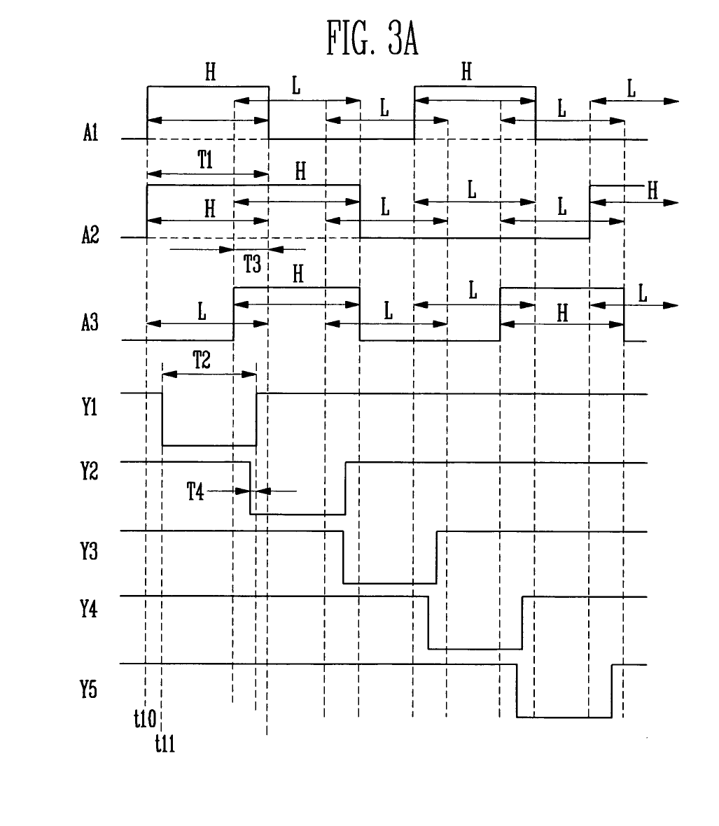

FIG. 3A illustrates driving waveforms supplied by an address period according to an embodiment of the present invention. When FIG. 3A is described, for convenience sake, it is assumed that three address electrodes and five scan electrodes are provided. Then, it is assumed that data pulses are supplied to a first address electrode to correspond to data of H, L, L, H, and L, that data pulses are supplied to a second address electrode to correspond to data of H, H, L, L, and L, and that data pulses are supplied to a third address electrode to correspond to data of L, H, L, L, and H. In this case, the data pulses (a high voltage) are supplied in the case of the data of H, and are not supplied in the case of the data of L.

Referring to FIG. 3A, according to an embodiment of the present invention, in the address period, scan signals are supplied to the scan electrodes Y1 to Y5 and the data signals are supplied to the address electrodes A1 to A3 in synchronization with the scan pulses. Each of the scan signals has at least one scan pulse, and each of the data signals has at least one data pulse. Here, the scan pulses are sequentially supplied to the scan electrodes Y1 to Y5. However, the present invention is not limited to the above. For example, the scan pulses can be supplied by an interlace method.

As described above, according to the present invention, the data pulses are supplied to overlap each other in a partial period. That is, as illustrated in FIG. 3B, a first data pulse supplied to correspond to a first scan pulse supplied to an ith (i is a natural number) scan line Yi overlaps with a second data pulse supplied to correspond to a second scan pulse supplied to an (i+1)th scan line Yi+1 in a second period T3.

As described above, when the data pulses overlap each other in the second period T3, the address period can be reduced. That is, when the data pulses overlap each other in the second period T3, the supply time of the data pulses can be reduced by the time of the second period T3. Therefore, the address period can be reduced. In particular, as a large number of scan electrodes are included, a reduction in the address period increases. Therefore, driving waveforms in which the data pulses partially overlap each other can be easily applied to a large panel.

On the other hand, the overlap time T3 of the data pulses can be set to be between 40 ns (nanoseconds) to 260 ns. When the overlap time T3 of the data pulses is set to be less than 40 ns, discharge delay time is stably reduced. When the overlap time T3 of the data pulses is larger than 260 ns, address discharge cannot be stably generated. Therefore, according to the present invention, a previous data pulse and a current data pulse overlap each other in a specific period between 40 ns to 260 ns to reduce the address period.

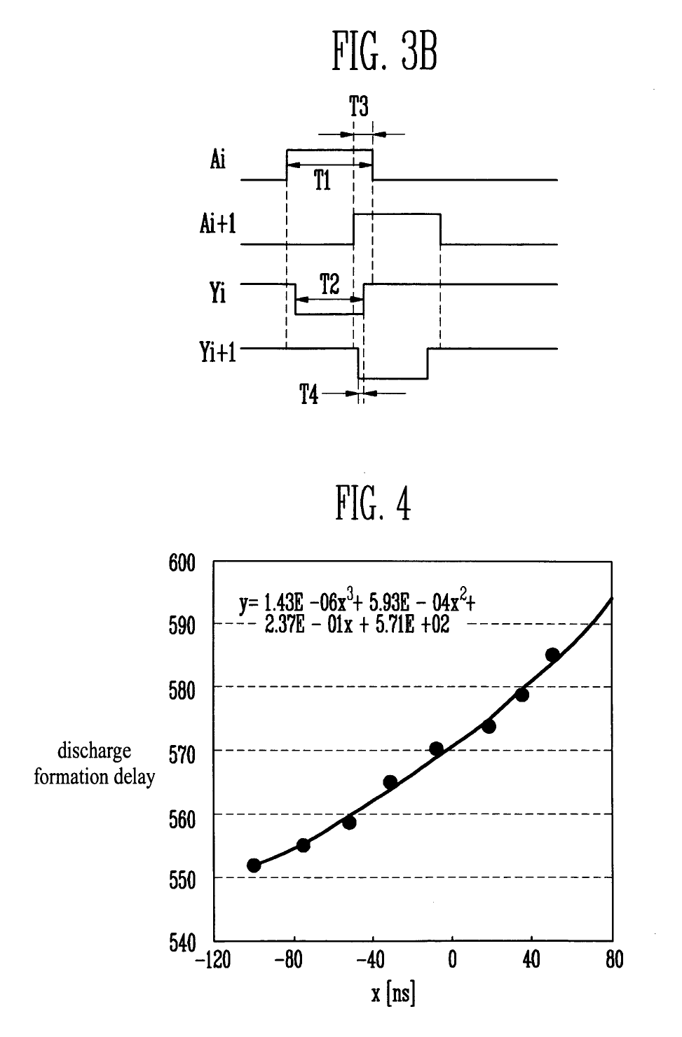

In addition, according to the present invention, the width T1 of the data pulse is set to be larger than the width T2 of the scan pulse. Actually, when it is assumed that the value obtained by subtracting the width T1 of the data pulse from the width T2 of the scan pulse is X, the discharge delay as shown in FIG. 4 is observed.

Referring to FIG.4, the discharge delay is reduced as the value of X is reduced, and increases as the value of X increases. On the other hand, in the graph of FIG. 4, a tertiary polynomial expression of Equation 1 is derived.

Y=1.43E−06X³+5.93E−04X²+2.37E−01X+5.71E+02 Equation 1

A derived function (a characteristic slope) of the Equation 1 is described in FIG. 5. In a viewpoint of a slope, a region 1 and a region 2 are provide in FIG. 5. The region 1 is a region of [−120, −40] and the region 2 is a region of [−40, 80]. Here, as X is smaller in the region 2 than in the region 1, the discharge delay time is reduced.

Therefore, according to the present invention, X is set to be no more than -40 ns. Here, when X is larger than −260 ns, the width of the scan pulses is so small so that erroneous discharge can be generated. Therefore, according to the present invention, the width T1 of the data. pulses is set to be larger than the width T2 of the scan pulses so that the range of X is set to be between 40 ns and 260 ns.

In this case, the rising point of time t10 of the data pulses is set to precede the falling point of time t11 of the scan pulses so that the address discharge can be stably generated by the data pulses and the scan pulses. Then, the scan pulses overlap the data pulses, and are supplied within the time when the data pulses are supplied. In addition, according to the present invention, the scan pulse supplied to the ith scan electrode Y1 and the scan pulse supplied to the (i+l)th scan electrodes Yi+1 overlap each other in a first period T4. Here, the first period T4 is set to be between 0 ns to 220 ns. When the first period T4 is larger than 220 ns, since the address discharge is not stably generated, the first period T4 is set to be between 0 ns and 220 ns.

As described above, according to the present invention, the data pulses are supplied to partially overlap each other so that the address period can be reduced. In addition, according to the present invention, the width T1 of the data pulses is set to be larger than the width T2 of the scan pulses so that the discharge delay can be minimized and that the address discharge can be stably generated.

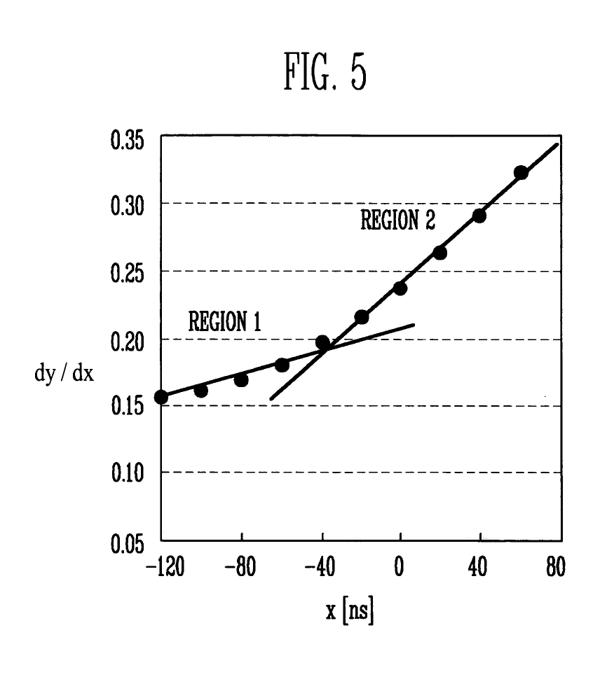

FIG. 6 illustrates a PDP according to an embodiment of the present invention. Referring to FIG. 6, the PDP according to an embodiment of the present invention includes a display panel 112, an address driver 102, a sustain driver 104, and a scan driver 106.

The display panel 112 includes scan electrodes Y1 to Yn and sustain electrodes X1 to Xn that run parallel to each other, and includes address electrodes A1 to Am that intersect the scan electrodes. Y1 to Yn. Here, discharge cells 114 are positioned in the parts where the scan electrodes Y1 to Yn, the sustain electrodes XI to Xn, and the address electrodes A1 to Am intersect each other. The present invention is not limited to the structure of the electrodes X, Y, and A that form the discharge cells 114 according to an embodiment of the present invention.

The sustain driver 104 supplies sustain pulses to the sustain electrodes X1 to Xn in a sustain period of a subfield.

The scan driver 106 supplies ramp pulses to the scan electrodes Y1 to Yn in a reset period of a subfield, and supplies the scan pulses to the scan electrodes Y1 to Yn in the address period. Then, the scan driver 106 supplies the sustain pulses to the scan electrodes Y1 to Yn to alternate with the sustain electrodes X1 to Xn in the sustain period of the subfield. Here, the scan driver 106 supplies the scan pulses to the scan electrodes Y1 to Yn in the address period so that the scan pulses overlap each other in the first period T4.

The address driver 102 supplies the data pulses to the address electrodes A1 to Am in the address period to select discharge cells 114 to be turned on (or turned off). Here, the address driver 102 supplies the data pulses to the address electrodes A1 to Am in the address period so that the data pulses overlap each other in the third period T3. Therefore, an output end (not shown) is included in the address driver 102.

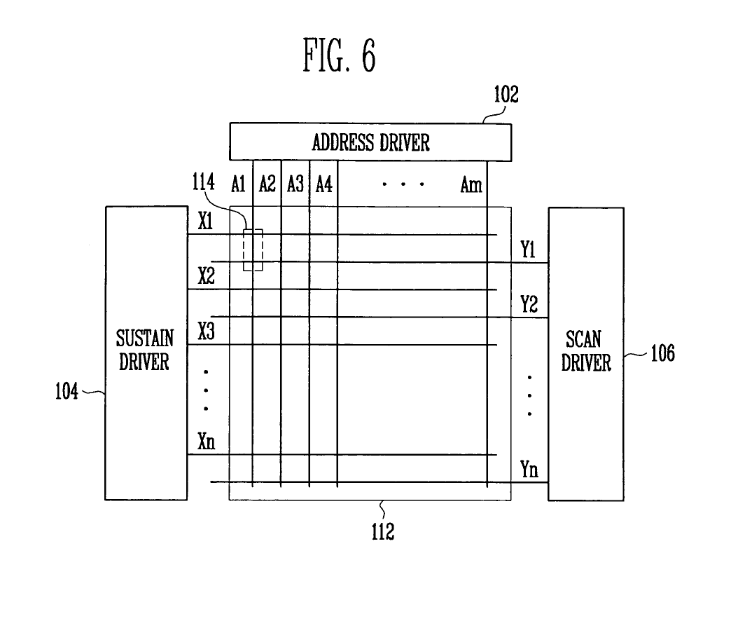

FIG. 7 schematically illustrates an output end for supplying the data pulses to the address electrodes. Referring to FIG. 7, the output end according to an embodiment of the present invention includes first switches SW11 to SW1m coupled between the address electrodes A1 to Am and an address voltage source Va, second switches SW21 to SW2m coupled between the address electrodes A1 to Am and an energy recovery capacitor Cex, and third switches SW31 to SW3m coupled between the address electrodes A1 to Am and a base voltage source GND.

The first switches SW11 to SW1m are selectively turned on to correspond to first control signals supplied from the outside to supply the address voltage Va to the address electrodes A1 to Am.

The second switches SW21 to SW2m are selectively turned on to correspond to second control signals supplied from the outside to supply the voltage charged in the energy recovery capacitor Cex to the address electrodes A1 to Am. Here, the energy recovery capacitor Cex is commonly coupled with the second switches SW21 to SW2m. However, the present invention is not limited to the above. For example, energy recovery capacitors Cex can be coupled with the second switches SW21 to SW2m, respectively. In addition, an inductor (not shown) can be additionally provided between the second switches SW21 to SW2m and the energy recovery capacitor.

The third switches SW31 to SW3m are selectively turned on to correspond to third control signals supplied from the outside to supply the voltage of the base voltage source GND to the address electrodes A1 to Am.

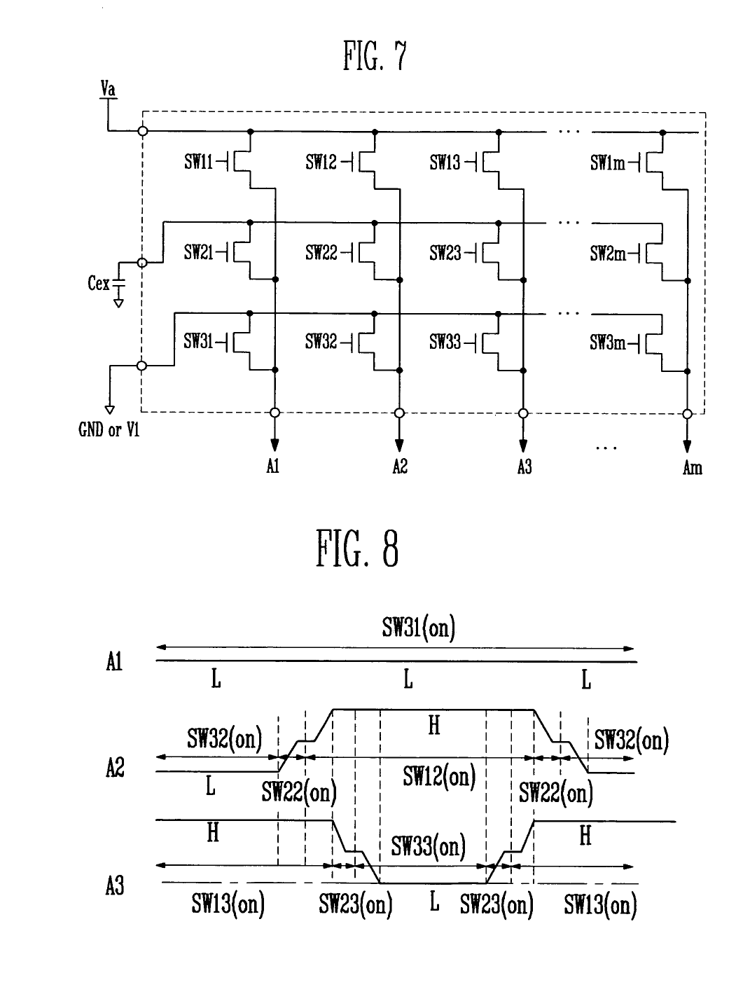

The operation processes of the output end according to the present invention will be described in detail with reference to FIG. 8. First, it is assumed that the data pulses corresponding to the data of L, L, and L are supplied to the first address electrode A1, that the data pulses corresponding to the data of L, H, and L are supplied to the second address electrode A2, and that the data pulses corresponding to the data of H, L, and H are supplied to the third address electrode A3.

The data pulses are not supplied to the first address electrode A1 that receives the data of L, L, and L. Therefore, the first one of the third switches SW31 coupled with the first address electrode A1 is maintained to be turned on and the voltage of the base voltage source GND is supplied to the first address electrode A1.

When the data of L is supplied to the second address electrode A2, the second one of the third switches SW32 is turned on so that the voltage of the base voltage source GND is supplied to the second address electrode A2. Then, the second one of the second switches SW22 is turned on at the point of time corresponding to the data of H so that the voltage charged in the energy recovery capacitor Cex is supplied to the second address electrode A2. Therefore, the voltage of the second address electrode A2 increases. Then, the second one of the first switches SW12 is turned on so that the address voltage Va, that is, the data pulse is supplied to the second address electrode A2.

After the data pulse is supplied to the second address electrode A2, the second one of the second switches SW22 is turned on at the point of time corresponding to the data of L. When the second one of the second switches SW22 is turned on, a partial voltage supplied to the second address electrode A2 is recovered by the energy recovery capacitor Cex. Therefore, the voltage of the second address electrode A2 is reduced. Then, the second one of the third switches SW32 is turned on so that the voltage of the base voltage source GND is supplied to the second address electrode A2.

The third one of the first switches SW13 is turned on at the point of time corresponding to the data of H so that the data pulse is supplied to the third address electrode A3. Then, the third one of the second switches SW23 is turned on at the point of time corresponding to the data of L so that a partial voltage is recovered by the energy recovery capacitor Cex and that the voltage of the third address electrode A3 is reduced. Then, the third one of the third switches SW33 is turned on so that the voltage of the base voltage source GND is supplied to the third address electrode A3. On the other hand, according to the present invention, the point of time at which the third one of the second switches SW23 is turned on is later than the point of time at which the second one of the second switches SW22 is turned on. Therefore, the data pulses are supplied to partially overlap each other.

After the voltage of the base voltage source GND is supplied to the third address electrode A3, the third one of the second switches SW23 is turned on at the point of time corresponding to the data of H. When the third one of the second switches SW23 is turned on, the voltage of the energy recovery capacitor Cex is supplied to the third address electrode A3. Therefore, the voltage of the third address electrode A3 increases. Then, the third one of the first switches SW13 is turned on so that the data pulse is supplied to the third address electrode A3. On the other hand, the point of time at which the third one of the second switches SW23 is turned on is faster than the point of time at which the second one of the second switches SW22 is turned on. Therefore, the data pulses are supplied to partially overlap each other.

As described above, in the output end according to an embodiment of the present invention, the timings of the second switches SW2 1 to SW2m are controlled so that the data pulses are supplied to overlap each other. That is, the point of time at which the voltage charged in the energy recovery capacitor Cex is supplied to the address electrodes A in order to supply the data pulses to the address electrodes A is set not to overlap the point of time at which the voltage is recovered by the energy recovery capacitor Cex in order to supply the voltage of the base voltage source GND to the address electrodes A. That is, the point of time at which the data pulses rise is set not to overlap the point of time at which the data pulses fall so that the data pulses can be supplied to overlap each other.

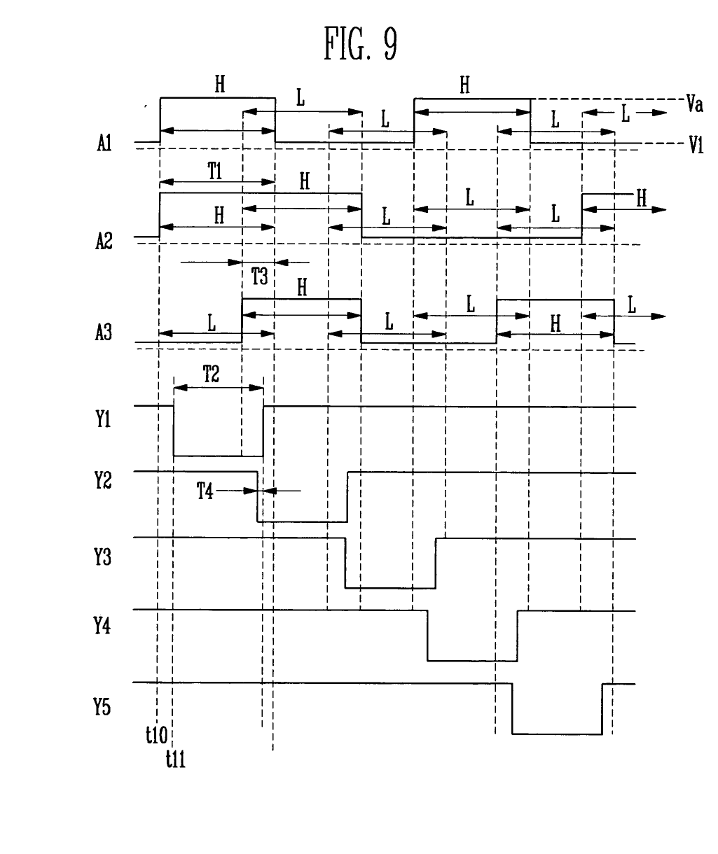

FIG. 9 illustrates driving waveforms supplied in the address period according to another embodiment of the present invention. In FIG. 9, detailed description of the same parts as FIG. 3A will be omitted.

Referring to FIG. 9, when the data pulses are supplied, the address voltage Va is supplied to the address electrodes A1 to A3. When the data pulses are not supplied, a first voltage V1 is supplied to the address electrodes A1 to A3. Here, the first voltage V1 is set to be higher than the voltage of the base voltage source GND. As described above, when the first voltage V1 is set to be higher than the voltage of the base voltage source GND, the withstand voltage of the circuit elements included in the address driver 102 can be reduced. Therefore, manufacturing cost can be reduced.

That is, in the case of the driving waveforms illustrated in FIG. 3A, the data pulses increase from the base voltage source GND to the address voltage Va (for example, 60 V). In this case, the withstand voltage is set to be about 100 V based on 60 V. However, as illustrated in FIG. 9, when the data pulses rise from the first voltage V1 (for example, 15 V) to the address voltage Va, the withstand voltage is set to be about 60 V based on 45 V. Therefore, the manufacturing cost can be reduced.

As described above, in the PDP according to an embodiment of the present invention and a method of driving the same, a previous data pulse and a current data pulse are supplied to overlap each other for a predetermined time so that the address period can be reduced. In addition, according to the present invention, the width of the data pulses is set to be larger than the width of the scan pulses so that the address discharge can be stably generated. In addition, according to the present invention, the voltage of the address electrodes is set to be higher than the voltage of the base voltage source GND when the data pulses are not supplied so that the manufacturing cost can be reduced.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A method of driving a plasma display panel (PDP) that includes scan electrodes and address electrodes, the PDP comprising:
supplying scan signals to the scan electrodes, each of the scan lines including a scan pulse; and
supplying data signals to the address electrodes, each of the data signals including a data pulse, each of the data signals being synchronized with one of the scan signals, the data pulse of the each of the data signals preceding the scan pulse of the synchronized scan signal.

2. The method as claimed in claim 1, wherein a rising point of time of the data pulse of the each of the data signals precedes a falling point of time of the scan pulse of the synchronized scan signal.

3. The method as claimed in claim 1, wherein a width of the data pulse of the each of the data signals is larger than a width of the scan pulse of the synchronized scan signal.

4. The method as claimed in claim 3, wherein the width of the data pulse is larger than the width of the scan pulse by between 40 nanoseconds and 260 nanoseconds.

5. The method as claimed in claim 1, wherein:
a scan pulse of one of the scan signals overlaps with a scan pulse of a next scan signal to the one of the scan signals by a first period; and
a data pulse of one of the data signals overlaps with a data pulse of a next data signal to the one of the data signals by a second period.

6. The method as claimed in claim 5, wherein the first period is no greater than 220 nanoseconds.

7. The method as claimed in claim 5, wherein the second period is between 40 nanoseconds and 260 nanoseconds.

8. The method as claimed in claim 1, wherein a voltage of a base voltage source is supplied to the address electrodes when the data pulses are not supplied to the address electrodes in an address period.

9. The method as claimed in claim 1, wherein a first voltage higher than a voltage of abase voltage source is supplied to the address electrodes when the data pulses are not supplied to the address electrodes in the address period.

10. A method of driving a plasma display panel (PDP) that includes scan electrodes and address electrodes, the PDP comprising:
supplying scan signals to the scan electrodes, each of the scan lines including a scan pulse; and
supplying data signals to the address electrodes, each of the data signals including a data pulse, each of the data signals being synchronized with one of the scan signals, a width of the data pulse of the each of the data signals being larger than a width of the scan pulse of the synchronized scan signal, a data pulse of one of the data signals overlapping with a data pulse of a next data signal to the one of the data signals by a second period.

11. The method as claimed in claim 10, wherein the width of the data pulse is larger than the width of the scan pulse by between 40 nanoseconds and 260 nanoseconds.

12. The method as claimed in claim 10, wherein a scan pulse of one of the scan signals overlaps with a scan pulse of a next scan signal to the one of the scan signals by a period between 0 nanoseconds and 220 nanoseconds.

13. The method as claimed in claim 10, wherein the second period is between 40 nanoseconds and 260 nanoseconds.

14. The method as claimed in claim 10, wherein a voltage of a base voltage source is supplied to the address electrodes when the data pulses are not supplied to the address electrodes in an address period.

15. The method as claimed in claim 10, wherein a first voltage higher than a voltage of a base voltage source is supplied to the address electrodes when the data pulses are not supplied to the address electrodes in the address period.

16. A plasma display panel (PDP), comprising:
a plurality of address electrodes;
a plurality of scan electrodes;
a scan driver for supplying scan signals to the scan electrodes;
first switches, each of which is coupled between an address voltage source and one of the address electrodes, the first switches being turned on in order to supply an address voltage to the address electrodes;
second switches, each of which is coupled between an energy recovery capacitor and one of the address electrodes, the second switches being turned on when a voltage of data pulses rises or falls; and
third switches, each of which is coupled between a base voltage source and one of the address electrodes, the third switches being turned on in order to supply a voltage of a base voltage source, wherein turning on and off timings of the second switches are controlled so that the rising point of time and the falling point of time of the data pulses do not overlap each other.
